(19) United States
(12) Patent Application Publication
(10) Pub. No.: US 2008/0209803 A1
(43) Pub. Date: Sep. 4, 2008

(54) Corporate body of vessel for a plant medicine for promoting nutrition

(76) Inventor: Sang Hwa Yoon, Incheon (KR)

Correspondence Address: STAAS & HALSEY LLP, SUITE 700, 1201 NEW YORK AVENUE, N.W., WASHINGTON, DC, 20005, US

(21) Appl. No.: 12/000,106

(22) Filed: Dec. 7, 2007

Related U.S. Application Data
(63) Continuation of application No. PCT/KR2006/003729, filed on Sep. 20, 2006.

(30) Foreign Application Priority Data
Jan. 6, 2006 (KR) 20-2006-0000474

(51) Int. Cl. A01G 29/00

(52) U.S. Cl. 47/48.5

(57) ABSTRACT

Disclosed is an aggregated body of vessels for plant food, in which a plurality of plant food vessels (1) is processed to be connected to each other, so that the resultant aggregated body (100) facilitates packing and storage of the plant food vessels, reduces distribution cost, can be produced at mass production volumes with high productivity, and allows a user to easily manage and use the plant food vessels after purchase.

The aggregated body includes a plurality of the plant food vessels connected to each other, each plant food vessel including a main body (10), a tapered outlet (20) provided at an upper end portion of the main body, and a cover (30) provided on the top of the tapered outlet. The connection between the plant food vessels is made with connection strips through a blowing method, and thus the connection is easily broken.

### CROSS-REFERENCE TO RELATED APPLICATIONS

This is a continuing application, filed under 35 U.S.C. §111(a), of International Application No. PCT/KR2006/003729, filed Sep. 20, 2006, it further being noted that foreign priority benefit is based upon Korean Patent Application No. 20-2006-0000474 filed Jan. 6, 2006, in the Korean Intellectual Property Office, the disclosures of which are incorporated herein by reference.

### BACKGROUND

1. Field

The present invention relates to an aggregated body of vessels for plant food for providing nutrition. More particularly, the present invention relates to an aggregated body of vessels for plant food for providing nutrition, which is designed to combine a plurality of plant food vessels, which thus facilitates packing and storage of a large number of plant food vessels, reduces the cost of distributing plant food, is able to be produced at mass production volumes, thus realizing high productivity, and allows a user to easily manage the plant food vessels.

2. Description of the Related Art

Generally, plant food, in which nutrients such as nitrogen (N), phosphorous (P) and potassium (K) are mixed at a suitable ratio, is used to make up for deficiencies of nutrients in flowers or other plants, such as orchids, which are generally grown in pots in homes or offices.

Such plant food is generally sold in a vessel having a circular cross section, in which the vessel generally has a main body, a tapered outlet and a cover for covering the outlet. When using the plant food, a user first uncovers the cover of the vessel and then sticks the outlet of the vessel in the soil in a pot, so that plant food gradually permeates into the soil in the pot and is absorbed by the roots of the plant in the pot.

The conventional plant food vessel is disadvantageous because it has a structure with a circular cross section. That is, a large space is required to store and pack the plant food vessels because a large number of gaps is needlessly present between the vessels. Accordingly, the conventional plant food vessels unnecessarily occupy a large packing space or a large storage space due to the gaps that exist between the vessels when they are packed or stored, resulting in high distribution costs.

Still further, since the conventional plant food vessel is generally individually produced one by one, productivity is very low.

Yet further, since the plant food vessel has a structure with a circular cross-section and is individually manufactured one by one, there is difficulty in packing or storing them because the plant food vessels are easily scattered. This problem affects all concerned parties, from manufacturers to distributors and users.

### SUMMARY

Additional aspects and/or advantages will be set forth in part in the description which follows and, in part, will be apparent from the description, or may be learned by practice of the invention.

### Technical Problem

Accordingly, the present invention has been devised in consideration of the aforementioned problems and conditions, and it is an object of the present invention to provide an aggregated body of vessels for plant food for providing nutrients, which is designed to combine a plurality of individual plant food vessels, each having a main body having a polygonal cross section, so that the aggregated body of vessels for plant food facilitates the packing and storage of plant food vessels, reduces the cost of distributing plant food and is able to be manufactured at mass production volumes.

It is a further object of the present invention to provide an aggregated body of vessels for plant food, which allows plant food to be sold in bundles of vessels, so that a user can easily manage the plant food vessels during storage thereof and can conveniently use them by separating one vessel from the bundle, that is, the aggregated body of vessels for plant food.

### Technical Solution

In order to achieve the above described advantageous effects and objects, in accordance with the present invention, there is provided an aggregated body of vessels for plant food, which is molded such that two or more plant food vessels, each comprising a main body having an angular cross-section, a tapered outlet provided to a portion of the main body and a cover provided to the top of the tapered outlet, are connected.

The manner in which two or more plant food vessels are connected is implemented as a connection strip.

### ADVANTAGEOUS EFFECTS

As can be known through the embodiment of the present invention, thanks to the aggregated body according to the present invention, the size of the gap between plant food vessels is minimized when the plant food vessels are packed or stored. Accordingly, packing space or a storage space for plant food vessels can be most efficiently used, which results in a reduction of distribution cost.

Further, since a plurality of plant food vessels is manufactured at one time through a single process, the plant food vessels are manufactured at mass production volumes with high productivity in a short time.

Still further, because the plurality of plant food vessels is manufactured and sold by the bundle, a user can easily manage the plurality of plant food vessels and use plant food by separating plant food vessels one by one from the bundle, that is, the aggregated body.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a perspective view illustrating an aggregated body of vessels for plant food according to one embodiment of the present invention;

FIG. 2 is a plan view illustrating the aggregated body of vessels for plant food shown in FIG. 1;

FIG. 3 is a cross sectional view illustrating a plant food vessel according to one embodiment of the present invention; and

FIG. 4 is a perspective view illustrating a state in which one plant food vessel is separated from an aggregated body of vessels for plant food according to one embodiment of the present invention.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Hereinafter, an aggregated body of vessels for plant food according to one embodiment of the present invention will be described with reference to accompanying drawings.

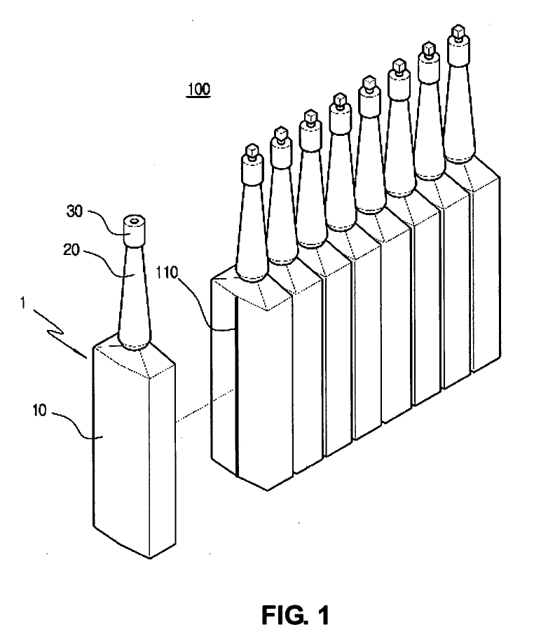

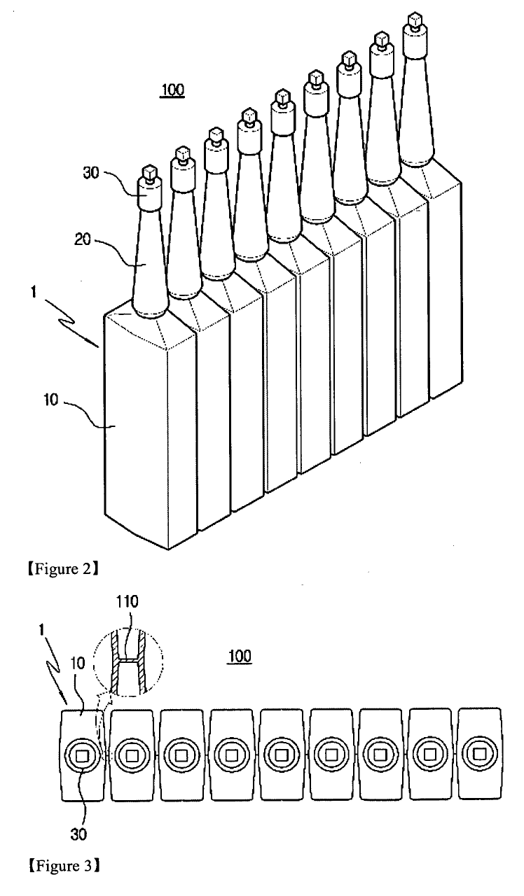

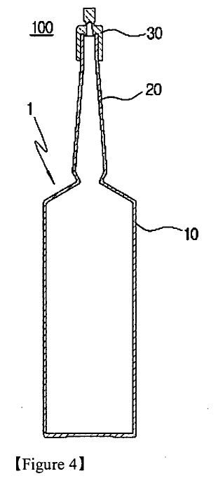

FIG. 1 is a perspective view illustrating an aggregated body of vessels for plant food according to one embodiment of the present invention, FIG. 2 is a plan view illustrating the aggregated body of vessels for plant food shown in FIG. 1, FIG. 3 is a cross sectional view illustrating a plant food vessel according to one embodiment of the present invention, and FIG. 4 is a perspective view illustrating a state in which one plant food vessel is separated from an aggregated body according to one embodiment of the present invention.

As shown in the drawings, an aggregated body 100 of vessels for plant food according to one embodiment of the present invention is designed in a manner such that a plurality of plant food vessels 1 is combined.

The plant food vessel 1, which constitutes the aggregated body 100, comprises a main body 10, an outlet 20 and a cover 30.

The main body 10 is charged with plant food and has a rectangular cross section or a pseudo-rectangular cross section. Even though the main body 10 according to the embodiment of the present invention is thin and has a rectangular cross section, the shape and thickness of the main body 10 is not limited to the embodiment of the present invention but can be modified in a variety of forms as long as the shape of the cross section is similar to the rectangular shape.

The outlet 20 extends up from the upper end portion of the main body 10, and an inner space thereof continues to an inner space of the main body 10. The outlet 20 is tapered in a manner such that the size thereof becomes smaller as it goes up to an upper end thereof, which is open.

The cover 30 is coupled to the open upper end of the outlet 10 in order to prevent plant food in the main body 10 from leaking out, so that plant food is discharged out through the open upper end of the outlet 20 when the cover 30 is separated therefrom.

The aggregated body 100, which comprises a plurality of plant food vessels 1, is manufactured through a variety of methods such as a blow molding method or an ejection molding method, such that the plurality of plant food vessels 1 is connected at surfaces thereof by connection strips. Accordingly, a user can use plant food by separating the plant food vessels one by one from the aggregated body 100.

In the embodiment of the present invention, the aggregated body 100 comprises 9 plant food vessels, but the present invention is not limited thereto. That is, the number of plant food vessels constituting the aggregated body 100 can vary.

As described above, since the plant food vessel 1 of the aggregated body 100 has a rectangular or a pseudo-rectangular cross section, when packing a plurality of aggregated bodies 100 in a box, the plant food vessels 1 are in close contact with each other due to the planar side surfaces thereof. That is, the vessels 1 are packed in a box without large gaps being formed between them, and thus the packing space in the box can be effectively used.

Moreover, in addition to the case in which the vessels 1 are packed in a packing box, the vessels 1 occupy a small space when the vessels 1 are stored for distribution and use. That is, a relatively large number of plant food vessels 1 according to the embodiment of the present invention can be stored in the same size of space in comparison with conventional plant food vessels.

Further, since the plurality of plant food vessels 1 constitutes one aggregated body 100 and is manufactured through a blowing method, the plant food vessels 1 can be manufactured at mass production volumes.

Still further, since the plurality of plant food vessels 1 is provided by the bundle, a user can easily manage and store them because they are not scattered. Accordingly, a large number of plant food vessels can be neatly stored in a storage space, and a user separates the plant food vessels from the aggregated body 100 one by one when they are needed.

### INDUSTRIAL APPLICABILITY

As described above, the aggregated body of vessels for plant food allows just a small gap to exist between plant food vessels when the plant food vessels are packed or stored. Accordingly, thanks to the aggregated body, packing space or storage space for plant food vessels can be efficiently used. This results in reduced distribution cost.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An aggregated body of vessels for plant food, comprising:
two or more plant food vessels which are connected to each other when they are manufactured through a molding method, each plant food vessel including a main body, a tapered outlet provided at an upper end portion of the main body and a cover detachably provided to a top of the tapered outlet.

2. The aggregated body according to claim 1, wherein the connection between the two or more plant food vessels is made with connection strips through a blowing method so that the plant food vessels can be easily separated from each other.
